(19) United States
(12) Patent Application Publication
(10) Pub. No.: US 2025/0003642 A1
(43) Pub. Date: Jan. 2, 2025

(54) REFRIGERANT FLUID

(71) Applicant: ANGELANTONI TEST TECHNOLOGIES S.R.L. - IN BREVE ATT S.R.L., Massa Martana (PG) (IT)

(72) Inventors: Patrizio PARRABBI, Massa Martana (PG) (IT); Filippo CAPODAGLIO, Massa Martana (PG) (IT)

(21) Appl. No.: 18/263,415

(22) PCT Filed: Feb. 9, 2022
(86) PCT No.: PCT/IB2022/051163

§ 371 Date: Jul. 28, 2023

(30) Foreign Application Priority Data
Feb. 16, 2021 (IT) 102021000003530

(51) Int. Cl. F25B 9/00; C09K 5/04; F25B 7/00

(52) U.S. Cl. CPC F25B 9/008; C09K 5/045; F25B 7/00; C09K 2205/106; C09K 2205/122; F25B 2400/12

(57) ABSTRACT

A refrigerant fluid for a refrigeration device (10) comprising a gas mixture, said gas mixture comprising at least carbon dioxide, 1,1,1,2-tetrafluoroethane and difluorom ethane, wherein said carbon dioxide has a mass percentage between 50% and 69% with respect to the total mixture, characterized in that said 1, 1,1,2-tetrafluoroethane has a mass percentage between 22.1% and 42% with respect to the total mixture, and said difluoromethane has a mass percentage between 7% and 13% with respect to the total mixture.

### FIELD OF THE INVENTION

The present invention relates to a refrigerant fluid. In particular, such refrigerant fluid is used in the refrigeration devices operating in environmentally controlled test chambers. Such test chambers have internally an insulated space inside which it is possible to insert a mechanical body to be tested in various conditions of temperature, humidity and pressure. Within such insulated space, it is often necessary to reach extremely low temperatures, even below minus 60° C. (or −60° C. or even 213.15 K).

### KNOWN PRIOR ART

It is known that, according to legislative provisions, a refrigerant fluid must not contribute significantly either to the widening of the ozone hole in the atmosphere or to the global warming. Therefore, halogenated compounds, in particular fluorinated gases or chlorinated substances, can no longer be used as refrigerants. Furthermore, the refrigerant used in the refrigeration devices must be non-flammable, so as to make the filling, shipping and operating the test chamber easier and safer, in light of the safety regulations that may have to be observed. Furthermore, the production of a circuit inside which the refrigerant fluid flows, inside a refrigeration device, becomes more expensive when a flammable refrigerant is used, due to the technical measures required in that case. In this context, flammability means that the refrigerant reacts with ambient oxygen, producing heat. A refrigerant is flammable, in particular, if it falls into the A2L, A2 and A3 C fire class in accordance with to EN378 or Din 378 Regulation.

Again, a refrigerant should have a relatively low CO₂ equivalent. In practice, its relative global warming power or GWP should be as low as possible, so as to avoid indirect damage to the environment in case of refrigerant release. GWP measures the defined amount of mass of a greenhouse gas that contributes to the global warming. Such value is established by considering carbon dioxide as a reference, which, therefore, is the reference value. GWP therefore describes the average warming effect over a specific time interval, 100 years in this context, of a given gas or gas mixture. Regarding the definition of the CO₂ equivalent, or related GWP, reference will be made herein and herein below to the (EU) Regulation No. 517/2014 of the European Parliament and Council.

In light of the aforementioned considerations, refrigerant fluids have been developed that have a low GWP and yet are not flammable.

In this regard, among others, refrigerant fluids are known that adopt a mixture comprising carbon dioxide, 1,1,1,2-tetrafluoroethane (or also known as R134a) and difluoromethane (or also known as R32).

In particular, Document WO9602606A1 in the name of Imperial Chemical Industries PLC, according to a first embodiment, describes a mixture that contains a percentage by weight of 2 to 15% carbon dioxide with respect to the total mixture, 30 to 96% R134a, and 2 to 55% R32. According to a further embodiment of the same Patent, the mixture contains a percentage by weight of 1 to 20% CO₂ with respect to the total mixture, 5 to 60% R134a, and 30 to 90% R32.

Document WO00/66678 in the name of Clodic Devis et al. also describes a mixture comprising carbon dioxide, R134a, and R32. However, in such Patent, the refrigerant mixture contains a mass percentage of 3 to 7% carbon dioxide, 65 to 75% R134a and 15 to 25% R32 with respect to the total mixture.

Still, Document JPH06867870 in the name of Daikin Industries LTD describes a refrigerant fluid constituted by a mixture comprising CO₂, R134a and R32 in the following mass percentages with respect to the total: 1 to 3% carbon dioxide, 25 to 35% R32 and 74 to 62% R134a.

Finally, Document JPH06220435 in the name SHOWA DENKO KK describes a further refrigerant fluid that comprises carbon dioxide, R32, and R134a. In one of the embodiments described in the Japanese Document mentioned above, R32, R134a and carbon dioxide have mass percentages with respect to the total mixture of 5.70%, 89.47%, and 4.82%, respectively.

Although the aforementioned mixtures are capable of operating in the conventional refrigeration devices, have an extremely low GWP and are non-flammable, they are nevertheless unable to reach temperatures below minus 50° C. (or −50° C. or also 223.15 K) inside the insulated space of the test chamber where the component being tested is placed.

There are also different mixtures of refrigerant fluids constituted by carbon dioxide and pentafluoroethane (R125). For example, Patent Application US2019/0093926 in the name of WEISS UMWELTTECHNIK GMBH describes precisely a refrigerant constituted by carbon dioxide and pentafluoroethane (R125), in which the mass fraction of carbon dioxide is between 20 and 80%. Such a solution, however, not only cannot technically reach a temperature below minus 57° C. (or −57° C. or also 216.15 K), but has a high GWP. Furthermore, such a mixture, in the event of extremely low temperature demand, risks freezing inside the circuit of the refrigeration device, thus causing enormous problems to the entire environmentally controlled test chamber in which the refrigeration device is installed.

International Patent Application PCT/IB2020/062008 in the name of the Applicant describes a refrigerant gas comprising a gas mixture comprising in turn at least carbon dioxide, 1,1,1,2-tetrafluoroethane (or R134a) and difluoromethane (or R32), wherein the carbon dioxide has a mass percentage greater than 50% with respect to the total mixture. According to a particular embodiment of the invention, carbon dioxide has a mass percentage between 50% and 75%, preferably 69% of the mixture. Furthermore, 1,1,1,2-tetrafluoroethane has a mass percentage between 12.5% and 22%, preferably 19%, with respect to the total mixture, while difluoromethane has a mass percentage between 9% and 19%, preferably 12%, of the total mixture.

Also this mixture, although compared to the others allows to reach temperatures well below minus 57° C. (or −57° C. or also 216.15 K), even reaching minus 78° C. (or −78° C. or also 195.15), and has a very low GWP, i.e. less than 380 over 100 years, however in some applications where it is required to reach even lower temperatures, i.e. below minus 78° C. (or −78° C. or also 195.15), it results in not being able to meet this demand.

Therefore, object of the present invention is to make a refrigerant fluid which contains in particular carbon dioxide, difluoromethane and 1,1,1,2-tetrafluoroethane and which is also capable of reaching temperatures inside an environmentally controlled chamber below minus 78° C. (or −78° C. or also 195.15 K).

Further object of the present invention is to make a refrigerant mixture that is non-flammable and has a GWP value that is in any case very low and comparable with that of the mixtures obtainable by means of Patent PCT/IB2020/062008 in the name of the Applicant.

Still, object of the present invention is to identify a refrigerant that is able to replace the R23 gas that until now has been used in the refrigeration devices present in environmentally controlled test chambers where it is desired to reach temperatures below minus 78° C. and that is at the same time characterized by a very low GWP.

Finally, object of the present invention is to make a refrigerant fluid that can also circulate in the refrigeration devices used in the existing environmentally controlled test chambers, without the need for the refrigeration devices installed therein to be modified, but on the contrary, also succeeds in reducing the discharge temperature of the low-stage compressor and enables the cooling power of the refrigeration unit to be increased.

### SUMMARY OF THE INVENTION

These and other objects are achieved by a refrigerant fluid for a refrigeration device, comprising a gas mixture, said gas mixture comprising at least carbon dioxide, 1,1,1,2-tetrafluoroethane (or R134a) and difluoromethane (or R32), wherein said carbon dioxide, or CO₂, has a mass percentage between 50% and 69% with respect to the total mixture, characterized in that said 1,1,1,2-tetrafluoroethane, or R134a, has a mass percentage between 22.1% and 42% with respect to the total mixture, and said difluoromethane, or R32, has a mass percentage between 7% and 13% with respect to the total mixture.

The Proprietor experienced that the presence of a greater amount of 1,1,1,2-tetrafluoroethane (or R134a) in the final refrigerant fluid with respect to that described in Patent Application PCT/IB2020/062008 allows the discharge temperature of the low-stage compressor to be reduced by more than 20% and, at the same time, to increase the cooling power of the refrigeration unit below −60° C. evaporation by more than 10%. Furthermore, it has been experienced that the solution described above, thanks exactly to the increased percentage used of 1,1,1,2-tetrafluoroethane with respect to the preferred solution described in Patent Application PCT/IB2020/062008 and overcoming a technological prejudice according to which a minimum temperature reachable by the refrigerant higher than minus 78° C. (or −78° C.) should have been obtained, on the other hand, it made it possible to reach temperatures in the environmentally controlled test chambers of less than minus 78° C. (or −78° C.), even reaching temperatures between minus 85° C. (or −85° C.) and minus 90° C. (or −90° C.) (depending on the different concentrations of 1,1,1,2-tetrafluoroethane used in the mixture), while still being characterized by a very low GWP.

According to a first embodiment of the invention, carbon dioxide has a mass percentage between 57% and 63%, preferably 60% of the mixture. Furthermore, 1,1,1,2-tetrafluoroethane has a mass percentage between 27% and 33%, preferably 30% with respect to the total mixture.

Such a solution has a GWP equal to 497.1 over 100 years.

According to a further embodiment of the invention, carbon dioxide has a mass percentage between 63% and 69%, preferably 66% with respect to the total mixture. In this case, 1,1,1,2-tetrafluoroethane has a mass percentage between 22.1% and 27%, preferably 24% with respect to the total mixture.

Such a solution has a GWP equal to 411.36 over 100 years.

According to a third embodiment of the invention, carbon dioxide has a mass percentage between 51% and 57%, preferably 54% of the mixture. In this further embodiment, 1,1,1,2-tetrafluoroethane has a mass percentage between 33% and 42%, preferably 36% with respect to the total mixture.

Such a solution has a GWP equal to 582.84 over 100 years.

In short, the GWP over 100 years of the three solutions is only slightly higher than that of the solution described in Patent PCT/IB2020/062008 in the name of the Proprietor, but compared to that mixture the aforementioned solutions allow reaching temperatures below −78° C.

Moreover, the invention provides a refrigeration apparatus provided with a refrigeration device having a closed circuit within which a refrigerant fluid circulates; said closed circuit is provided with at least one compressor, cooling means for said refrigerant fluid, expansion means for said refrigerant fluid and at least one evaporator, characterized in that a refrigerant fluid according to one or more of claims 1 to 7 circulates inside said closed circuit.

Moreover, such apparatus comprises a second refrigeration device having a second closed circuit within which a second refrigerant fluid circulates; said second closed circuit is provided with at least one second compressor, second cooling means for said second refrigerant fluid, second expansion means for said second refrigerant fluid and at least one second evaporator, wherein said at least one second evaporator is used for cooling the refrigerant fluid circulating inside said cooling means of said closed circuit, and wherein said second refrigerant fluid is distinct from said refrigerant fluid. In particular, preferably, said second refrigerant fluid comprises R404A, or R449A, or R452A, or other refrigerant fluid having similar thermodynamic properties, in particular capable of condensing at a temperature close to room temperature.

Finally, an environmentally controlled test chamber having an insulated space within which a specimen to be tested is inserted and comprising a refrigeration apparatus according to one or more of claims 8 to 10, is also provided.

### DESCRIPTION OF THE FIGURES

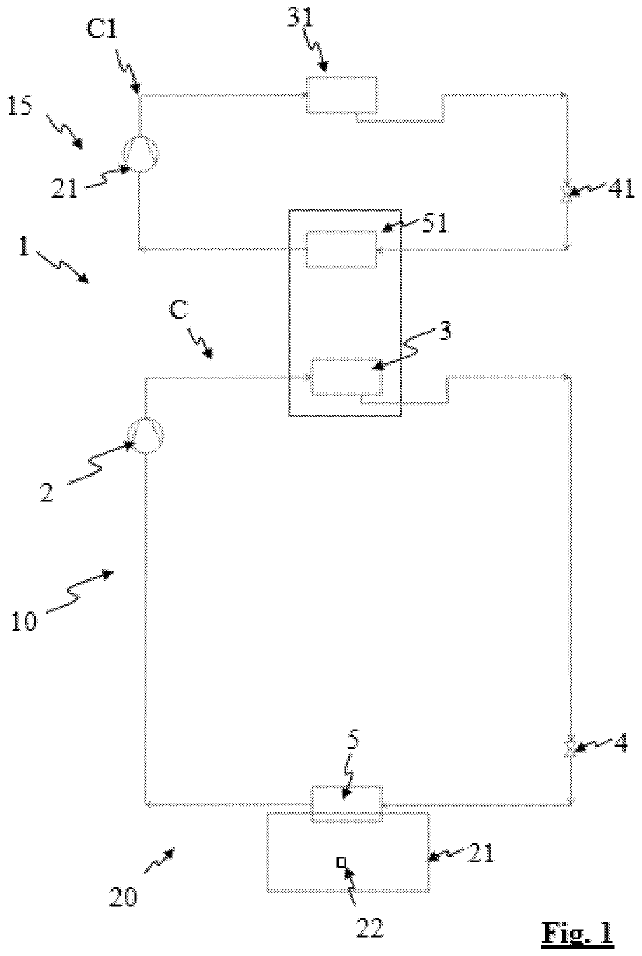

Some particular embodiments of the present invention will now be described by way of non-limiting example with reference to the accompanying FIG. 1, which shows a schematic view of the refrigeration apparatus of an environmentally controlled test chamber provided therein with an insulated space within which a test specimen is arranged.

### DETAILED DESCRIPTION OF A PREFERRED EMBODIMENT OF THE PRESENT INVENTION

In FIG. 1 is shown, in a simplified manner, a refrigeration apparatus 1 provided with a refrigeration device 10 having a closed circuit C inside which a flow rate of refrigerant fluid circulates. The closed circuit C comprises a main compressor 2, at least one cooling device 3 for the refrigerant fluid (in the case of phase change of the refrigerant fluid, also known as a condenser), expansion means 4 of the refrigerant fluid and an evaporator 5. The expansion means 4, which in the particular case comprise an expansion valve of the thermostatic type, in other embodiments may comprise a capillary line or other mechanism, without thereby departing from the scope of protection of the present invention.

The apparatus 1 further comprises a second refrigeration device 15 having a second closed circuit C1 inside which a second refrigerant fluid circulates. Such second closed circuit C1 is provided with a second compressor 21, second cooling means 31 for the second refrigerant fluid, second expansion means 41 for the second refrigerant fluid and a second evaporator 51. According to the embodiment described herein, the second evaporator 51 is used for cooling and/or condensing the refrigerant fluid circulating inside the cooling means 3 of the closed circuit C of the refrigeration device 10. In practice, the apparatus 1 comprises two refrigeration devices 10 and 15, which are cascaded.

Such refrigeration apparatus 1 is employed in an environmentally controlled test (or trial) chamber 20 of the type known and not further described herein, nor depicted in detail in the attached FIGURE. Such chamber 20 is provided with an insulated space 21 where a mechanical specimen 22 to be tested under various environmental conditions is placed.

Advantageously, the second refrigerant fluid is distinct from the refrigerant fluid circulating in the closed circuit C of the refrigeration device 10 and, preferably, comprises R404A. As an alternative to R404A, such second refrigerant fluid may also comprise R449A, or R452A, or other refrigerant fluid having similar thermodynamic properties.

The refrigerant fluid according to the invention, which operates instead in the refrigeration device 10 inside the closed circuit C, comprises a gas mixture. Such mixture of gases comprises at least carbon dioxide, 1,1,1,2-tetrafluoroethane and difluoromethane, wherein carbon dioxide has a mass percentage between 50% and 69% with respect to the total mixture, 1,1,1,2-tetrafluoroethane has a mass percentage between 22.1% and 42% with respect to the total mixture, and difluoromethane has a mass percentage between 7% and 13% with respect to the total mixture.

According to a first embodiment, carbon dioxide has a mass percentage between 57% and 63%, preferably 60% of the mixture. Furthermore, according to this first embodiment of the invention, 1,1,1,2-tetrafluoroethane has a mass percentage between 27% and 33%, preferably 30% with respect to the total mixture. According to a specific mixture of the first embodiment, the mixture comprises carbon dioxide with a mass percentage of 60%, 1,1,1,2-tetrafluoroethane with a mass percentage of 30%, and difluoromethane with a mass percentage of 10% with respect to the total mixture.

According to a second embodiment of the invention, carbon dioxide has a mass percentage between 63% and 69%, preferably 66% with respect to the total mixture. 1,1,1,2-tetrafluoroethane has a mass percentage between 22.1% and 27%, preferably 24% with respect to the total mixture.

Thus, according to a specific mixture of the second embodiment, carbon dioxide has a mass percentage of 66%, 1,1,1,2-tetrafluoroethane has a mass percentage of 24%, and difluoromethane has a mass percentage of 10% with respect to the total mixture. Finally, according to a third embodiment of the invention, carbon dioxide has a mass percentage between 51% and 57%, preferably 54% of the mixture. Furthermore, 1,1,1,2-tetrafluoroethane has a mass percentage between 33% and 42%, preferably 36% with respect to the total mixture.

Thus, according to a specific mixture of the third embodiment, carbon dioxide has a mass percentage of 54%, 1,1,1,2-tetrafluoroethane has a mass percentage of 36%, and difluoromethane has a mass percentage of 10% with respect to the total mixture. The aforementioned compositions of the refrigerant mixture were found to be non-flammable.

The Proprietor also experienced that such composition of the refrigerant fluid is capable of making the insulated space 21 of the environmentally controlled chamber 20 reach a temperature well below −57° C. (or also 216.15 K), even down to temperatures between −85° C. (or also 188.15 K) and −90° C. (or also 183.15 K), depending on the particular mixture employed. Furthermore, the refrigerant fluid thus obtained has a very low GWP value, i.e. less than 600 over 100 years. Finally, such refrigerant fluid does not contribute to the widening of the ozone hole.

1. A refrigerant fluid for a refrigeration device (10) comprising a gas mixture, said gas mixture comprising at least carbon dioxide, 1,1,1,2-tetrafluoroethane and difluoromethane, wherein said carbon dioxide has a mass percentage between 50% and 69% with respect to the total mixture, wherein said 1,1,1,2-tetrafluoroethane has a mass percentage between 22.1% and 42% with respect to the total mixture, and said difluoromethane has a mass percentage between 7% and 13% with respect to the total mixture.

2. The refrigerant fluid according to claim 1, wherein said carbon dioxide has a mass percentage between 57% and 63%.

3. The refrigerant fluid according to claim 2, wherein said 1,1,1,2-tetrafluoroethane has a mass percentage between 27% and 33% with respect to the total mixture.

4. The refrigerant fluid according to claim 1, wherein said carbon dioxide has a mass percentage between 63% and 69%, with respect to the total mixture.

5. The refrigerant fluid according to claim 4, wherein said 1,1,1,2-tetrafluoroethane has a mass percentage between 22.1% and 27% with respect to the total mixture.

6. The refrigerant fluid according to claim 1, wherein said carbon dioxide has a mass percentage between 51% and 57% of the mixture.

7. The refrigerant fluid according to claim 6, wherein said 1,1,1,2-tetrafluoroethane has a mass percentage between 33% and 42% with respect to the total mixture.

8. A refrigeration apparatus (1) provided with a refrigeration device (10) having a closed circuit (C) inside which a refrigerant fluid circulates, said closed circuit (C) being provided with at least one compressor (2), cooling means (3) for said refrigerant fluid, expansion means (4) for said refrigerant fluid and at least one evaporator (5), characterized in that a refrigerant fluid according to claim 1 circulates inside said closed circuit (C).

9. The refrigeration apparatus (1) according to claim 8, comprising a second refrigeration device (15) having a second closed circuit (C1) inside which a second refrigerant fluid circulates, said second closed circuit (C1) being provided with at least one second compressor (21), second cooling means (31) for said second refrigerant fluid, second expansion means (41) for said second refrigerant fluid and at least one second evaporator (51), wherein said at least one second evaporator is used for cooling the refrigerant fluid circulating inside said cooling means (3) of said closed circuit (C), and wherein said second refrigerant fluid is distinct from said refrigerant fluid.

10. The refrigeration apparatus according to claim 9, wherein said second refrigerant fluid comprises R404A, or R449A, or R452A, or other refrigerant fluid having similar thermodynamic properties.

11. An environmentally controlled test chamber (20) having an insulated space (21) inside which a test specimen (22) to be tested is inserted and comprising a refrigeration apparatus (1) according to claim 8.

12. The refrigerant fluid according to claim 2, wherein said carbon dioxide has a mass percentage of 60% of the mixture.

13. The refrigerant fluid according to claim 3, wherein said 1,1,1,2-tetrafluoroethane has a mass percentage of 30% with respect to the total mixture.

14. The refrigerant fluid according to claim 4, wherein said carbon dioxide has a mass percentage of 66% with respect to the total mixture.

15. The refrigerant fluid according to claim 5, wherein said 1,1,1,2-tetrafluoroethane has a mass percentage of 24% with respect to the total mixture.

16. The refrigerant fluid according to claim 6, wherein said carbon dioxide has a mass percentage of 54% of the mixture.

17. The refrigerant fluid according to claim 7, wherein said 1,1,1,2-tetrafluoroethane has a mass percentage of 36% with respect to the total mixture.
